(19) United States
(12) Patent Application Publication
(10) Pub. No.: US 2021/0373789 A1
(43) Pub. Date: Dec. 2, 2021

(54) Storage System, Host, and Method for Optimizing Storage of a Sequence of Images

(71) Applicant: Western Digital Technologies, Inc., San Jose, CA (US)

(72) Inventors: Dinesh Kumar Agarwal, Bangalore (IN); Amit Sharma, Bengaluru (IN)

(73) Assignee: Western Digital Technologies, Inc., San Jose, CA (US)

(21) Appl. No.: 16/888,093

(22) Filed: May 29, 2020

(51) Int. Cl. G06F 3/06

(52) U.S. Cl. CPC G06F 3/0644; G06F 3/0673; G06F 3/0604

(57) ABSTRACT

A storage system, host, and method for optimizing storage of a sequence of images are provided. In one embodiment, a storage system is provided comprising a memory and a controller. The controller is configured to: receive, from a host, common image data that is shared by a plurality of images and delta image data that is different in each of the plurality of images; store the common image data and the delta image data in the memory; and create a map for the plurality of images, wherein each image of the plurality of images maps to a memory location of at least a part of the common image data and to a memory location of that image's delta image data. Other embodiments are provided.

### BACKGROUND

A host with an image capture device (e.g., a mobile phone with digital camera or a dedicated digital camera) can capture and send images to a storage system for storage. Some hosts can operate in a “continuous click” or “burst mode,” in which a sequence of images is captured over a short period of time when the user holds down the image capture button.

### BRIEF DESCRIPTION OF THE DRAWINGS

FIG. 1A is a block diagram of a non-volatile storage system of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the non-volatile storage system illustrated in FIG. 1A according to an embodiment.

FIG. 2B is a block diagram illustrating components of the non-volatile memory storage system illustrated in FIG. 1A according to an embodiment.

FIG. 3 is a block diagram of a host and storage system of an embodiment.

FIG. 4 is an illustration of a plurality of images captured by a host of an embodiment operating in burst mode.

FIG. 5 is an illustration of a storage technique of an embodiment.

FIG. 6 is a flow chart of a method performed by a host of an embodiment for optimizing storage of a sequence of images.

FIG. 7 is a flow chart of another method performed by a host of an embodiment for optimizing storage of a sequence of images.

FIG. 8 is a diagram illustrating a mapping operation performed by a storage system of an embodiment.

FIG. 9 is a diagram illustrating an advantage of a method of an embodiment for optimizing storage of a sequence of images.

FIG. 10 is a diagram illustrating communication between a host and a storage system of an embodiment.

FIG. 11 is a flow chart of a method performed by a storage system of an embodiment for optimizing storage of a sequence of images.

### DETAILED DESCRIPTION

Overview

By way of introduction, the below embodiments relate to a storage system, host, and method for optimizing storage of a sequence of images. In one embodiment, a storage system is provided comprising a memory and a controller. The controller is configured to: receive, from a host, common image data that is shared by a plurality of images and delta image data that is different in each of the plurality of images; store the common image data and the delta image data in the memory; and create a map for the plurality of images, wherein each image of the plurality of images maps to a memory location of at least a part of the common image data and to a memory location of that image's delta image data.

In some embodiments, the memory locations are identified by logical block addresses.

In some embodiments, the controller is further configured to maintain a reference count for each memory location of each part of the common image data.

In some embodiments, the controller is further configured to reduce the reference count of a memory location in response to an erase operation to that memory location.

In some embodiments, the controller is further configured to erase data at a memory location in response to the reference count of that memory location being zero.

In some embodiments, the controller is configured to create the map in response to receiving an indication from the host that the host is operating in a burst mode.

In some embodiments, the memory comprises a three-dimensional memory.

In some embodiments, the storage system is configured to be removably connected to the host.

In some embodiments, the storage system is configured to be embedded in the host.

In another some embodiment, a method is provided that is performed in a host in communication with a storage system. The method comprises: determining base data that is common to a plurality of images; determining delta data that is different in each of the plurality of images; and sending the base data and the delta data to the storage system, wherein a size of the base data and the delta data is less than a size of the plurality of images,

In some embodiments, the base data is from an image previously sent to the storage system.

In some embodiments, the host comprises an image capture device configured to capture the plurality of images.

In some embodiments, the plurality of images was taken while the host was in a burst mode, and wherein the method further comprises informing the storage system of the burst mode.

In some embodiments, the storage system is configured to be removably connected to the host.

In some embodiments, the storage system is configured to be embedded in the host.

In another embodiment, a storage system is provided comprising a memory; means for storing a first image received from a host in the memory; and means for performing the following for a second image received from the host: determining data that is common between the first image and the second image; determining data that is different between the first image and the second image; storing the data that is different, but not the data that is common, in the memory; and storing a reference to a location in the memory storing the data that is common.

In some embodiments, the storage system further comprises means for maintaining a count for a number of references to each memory location.

In some embodiments, the means for performing is activated in response to receiving an indication from the host that the host is operating in a burst mode.

In some embodiments, the storage system is configured to be removably connected to the host.

In some embodiments, the storage system is configured to be embedded in the host.

Other embodiments are possible, and each of the embodiments can be used alone or together in combination. Accordingly, various embodiments will now be described with reference to the attached drawings.

### Embodiments

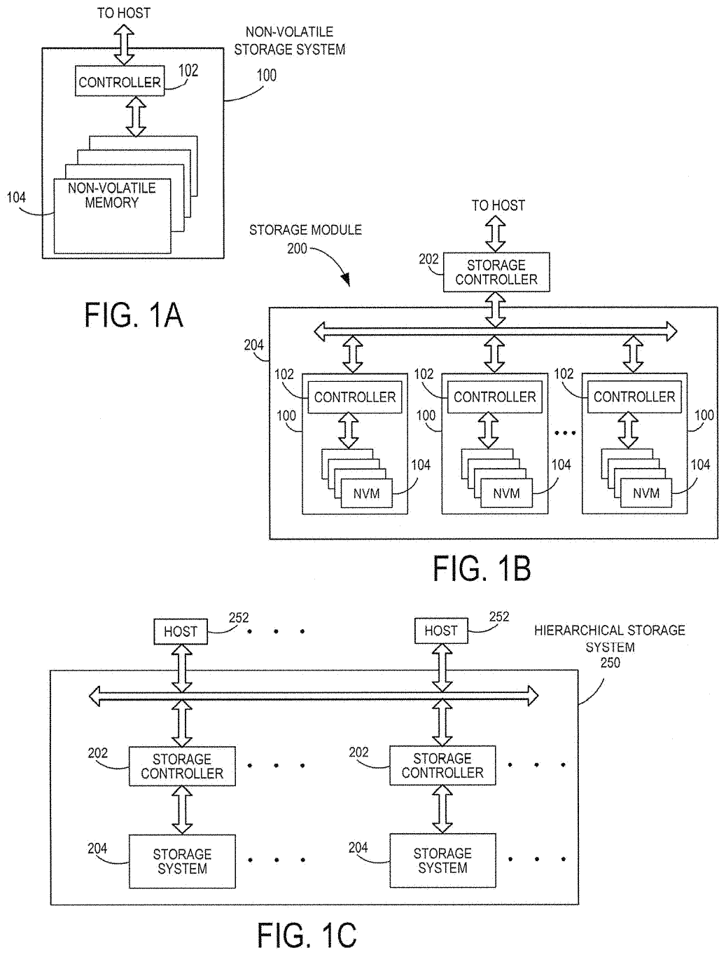

Storage systems suitable for use in implementing aspects of these embodiments are shown in FIGS. 1A-1C. FIG. 1A is a block diagram illustrating a non-volatile storage system 100 according to an embodiment of the subject matter described herein. Referring to FIG. 1A, non-volatile storage system 100 includes a controller 102 and non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104.

The controller 102 (which may be a non-volatile memory controller (e.g., a flash, resistive random-access memory (ReRAM), phase-change memory (PCM), or magnetoresistive random-access memory (MRAM) controller)) can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a non-volatile memory controller is a device that manages data stored on non-volatile memory and communicates with a host, such as a computer or electronic device. A non-volatile memory controller can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. (Alternatively, the host can provide the physical address.) The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, storage system 100 may be a card based system, such as a secure digital (SD) or a micro secure digital (micro-SD) card. In an alternate embodiment, storage system 100 may be part of an embedded storage system.

Although, in the example illustrated in FIG. 1A, non-volatile storage system 100 (sometimes referred to herein as a storage module) includes a single channel between controller 102 and non-volatile memory die 104, the subject matter described herein is not limited to having a single memory channel. For example, in some storage system architectures (such as the ones shown in FIGS. 1B and 1C), 2, 4, 8 or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile storage systems 100. As such, storage module 200 may include a storage controller 202 that interfaces with a host and with storage system 204, which includes a plurality of non-volatile storage systems 100. The interface between storage controller 202 and non-volatile storage systems 100 may be a bus interface, such as a serial advanced technology attachment (SATA), peripheral component interconnect express (PCIe) interface, or double-data-rate (DDR) interface. Storage module 200, in one embodiment, may be a solid state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective storage system 204. Host systems 252 may access memories within the storage system via a bus interface. In one embodiment, the bus interface may be a Non-Volatile Memory Express (NVMe) or fiber channel over Ethernet (FCoE) interface. In one embodiment, the system illustrated in FIG. 1C may be a rack mountable mass storage system that is accessible by multiple host computers, such as would be found in a data center or other location where mass storage is needed.

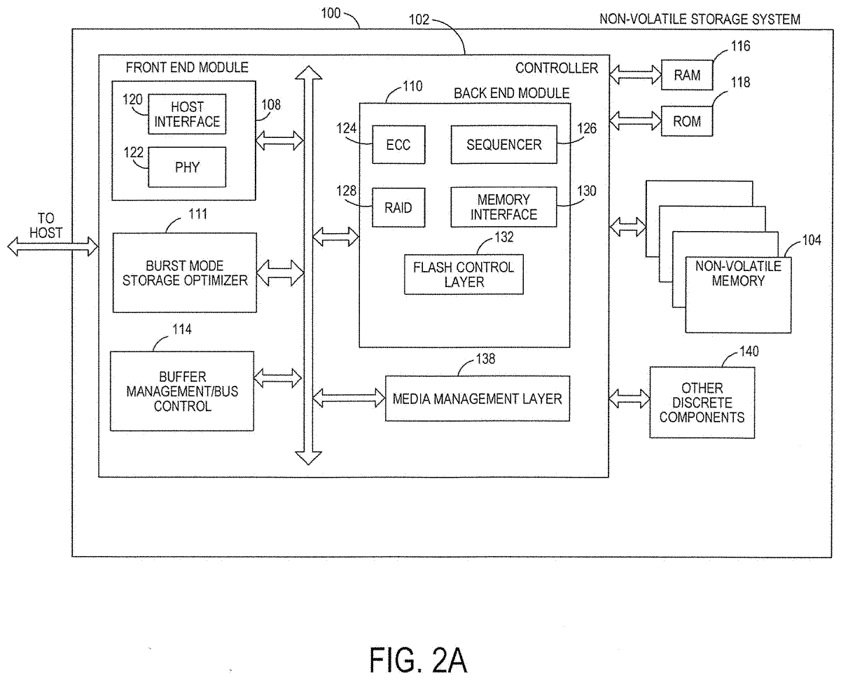

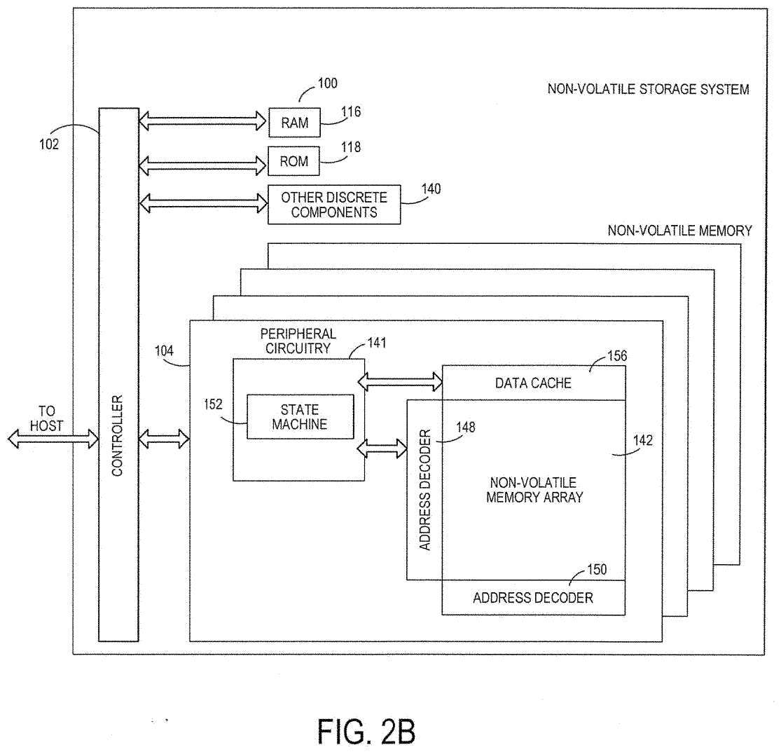

FIG. 2A is a block diagram illustrating components of controller 102 in more detail. Controller 102 includes a front end module 108 that interfaces with a host, a back end module 110 that interfaces with the one or more non-volatile memory die 104, and various other modules that perform functions which will now be described in detail. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example. Modules of the controller 102 may include a burst mode storage optimizer 111, which can be implemented in hardware and/or software (e.g., in a processor executing computer-readable program code) to implement the methods and algorithms described below.

Referring again to modules of the controller 102, a buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller.

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

The storage system 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two dimensional and/or three dimensional configuration. Non-volatile memory die 104 further includes a data cache 156 that caches data. Peripheral circuitry 141 includes a state machine 152 that provides status information to the controller 102.

Returning again to FIG. 2A, the flash control layer 132 (which will be referred to herein as the flash translation layer (FTL) or, more generally, the “media management layer,” as the memory may not be flash) handles flash errors and interfaces with the host. In particular, the FTL, which may be an algorithm in firmware, is responsible for the internals of memory management and translates writes from the host into writes to the memory 104. The FTL may be needed because the memory 104 may have limited endurance, may only be written in multiples of pages, and/or may not be written unless it is erased as a block. The FTL understands these potential limitations of the memory 104, which may not be visible to the host. Accordingly, the FTL attempts to translate the writes from host into writes into the memory 104.

The FTL may include a logical-to-physical address (L2P) map and allotted cache memory. In this way, the FTL translates logical block addresses (“LBAs”) from the host to physical addresses in the memory 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

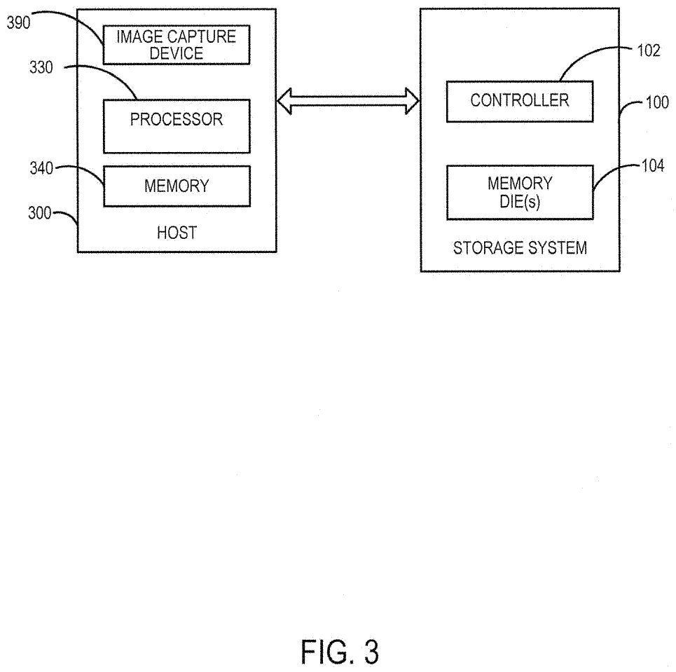

Turning again to the drawings, FIG. 3 is a block diagram of a host 300 and storage system (sometimes referred to herein as a device) 100 of an embodiment. The host 300 can take any suitable form, including, but not limited to, a computer, a mobile phone, a digital camera, a tablet, a wearable device, a digital video recorder, a surveillance system, etc. In one embodiment, the host 300 comprises an image capture device 390 (e.g., a camera) to take a picture, and the processor 330 generates a digital image representing that picture. The image can be stored in the memory 340 prior to sending the image to the storage system 100 (e.g., a memory card or an embedding storage device) for storage.

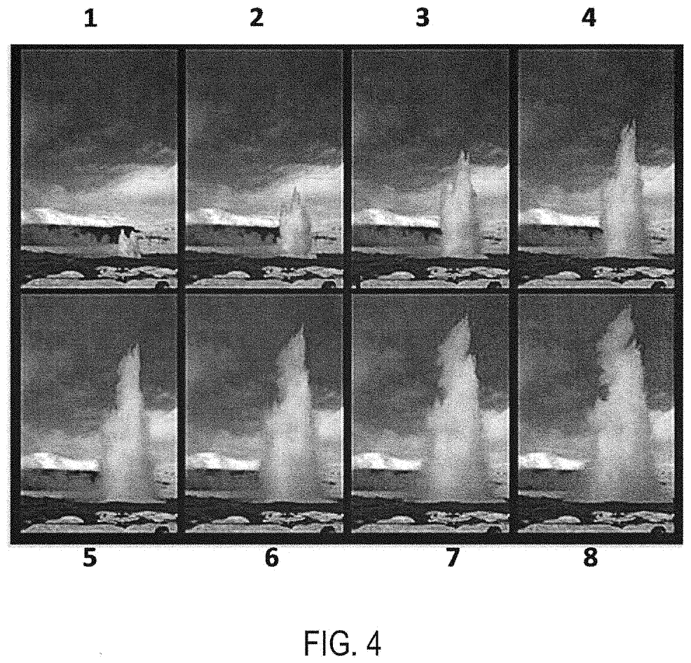

In this embodiment, the host 300 can operate in a “continuous click” or “burst mode,” in which the host 300 captures a sequence of images over a short period of time. Burst mode can be activated when the user holds down an image capture button on the host 300. FIG. 4 is an example of a plurality of images captured by the host 300 when operating in burst mode. As shown in FIG. 4, because the images were sequentially taken over a short period of time, many, if not all, of the images have the same properties (e.g., the same set of people or the same background).

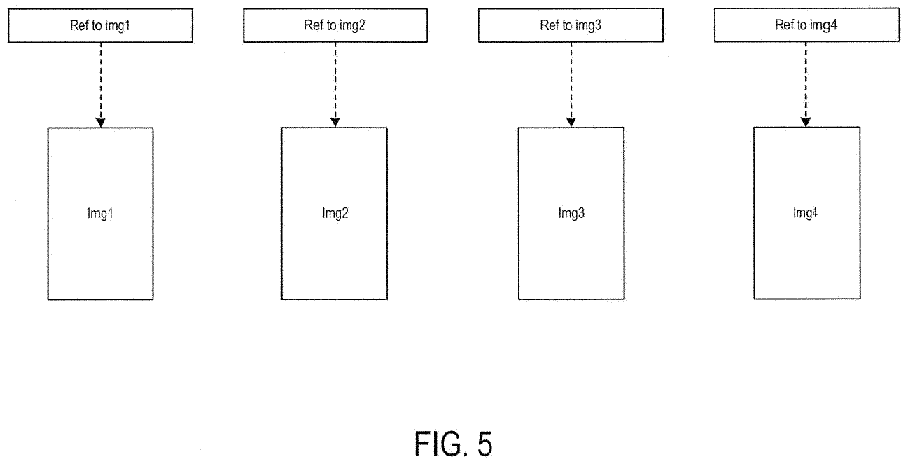

The amount of space required in the memory 104 of the storage system 100 to store burst mode images is generally high. For example, FIG. 5 illustrates a situation in which the host 300 takes four images in burst mode and sends all four images to the storage system 100 for storage. Assuming the size of each image is 4 megabytes (MB), the space needed in the memory 104 to store all four images separately is 32 MB, and 32 MB of data would be transferred on the bus between the host 300 and storage system 100.

The following embodiments recognize that because images taken at short intervals (burst mode) have shared image properties (e.g., the same set of people or the same background), there is opportunity to optimize bandwidth on the bus as well as optimize storage space utilization in the memory 104. In general, the host 300 and/or storage system 100 can analyze the plurality of images to determine what data is common and what data is different and store and/or transmit the common data only once. It should be noted that while these embodiments will be described in terms of burst mode, burst mode is not necessarily required. For example, the sequence of images can be captured over a longer period of time than with burst mode, or the images may not necessarily be a sequence of images. Accordingly, burst mode should not be read into the claims unless expressly recited therein. Further, it should be noted that while the host 300 in this embodiments contains an image capture device 390, these embodiments can also be used with the images are provided to the host 300 from another source.

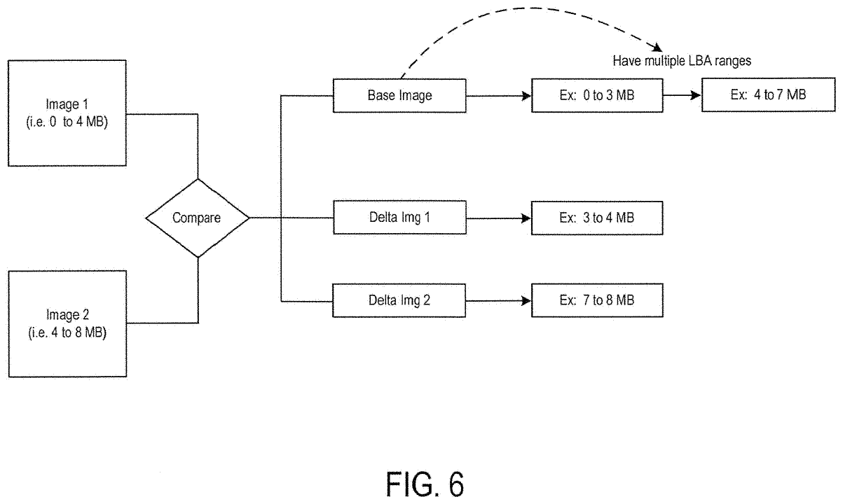

Returning to the drawings, FIG. 6 illustrates one embodiment in which the host 300 performs actions to help optimize storage of a plurality of images by detecting LBA ranges of common data in the plurality of images. In this embodiment, the host 300 identifies images taken over a short interval (burst mode) and sends the images as common and delta parts to storage system 100. More specifically, in this embodiment, the processor 330 of the host 300 analyzes a plurality of images taken over a short interval (in burst mode) to determine what parts of the images are the same (common) and what parts of the images are different (delta) with respect to an earlier image. In the example in FIG. 6, Image 1 and Image 2 are each 4 MB. The logical block address (LBA) of Image 1 is 0-4, and the LBA of Image 2 is 4-8 (assuming each LBA is 1 MB). The host processor 330 compares the two images and, in this example, determines that the first 3 MB of image data are common to both images. That means that the data stored in LBA 0-3 in Image 1 is the same as the data stored in LBA 4-7 in Image 2. As such, the common data (referred to as the “base image” in FIG. 6) only needs to be sent to the storage system 100 once. The data that is different between the images (the “delta data”) can all be sent to the storage system 100. In this example, the delta data is in LBA 3-4 in Image 1 and LBA 7-8 in Image 2. Because the common data is only sent once, the amount of data sent over the bus and stored in the memory 104 of the storage system 100 is less (i.e., the size of the base data and the delta data is less than a size of both full images). More specifically, because the two images are 4 MB each in this example, sending both full images would result in 8 MB of data being sent over the bus and stored in the storage system's memory 104. Instead, with this embodiment, only 5 MB of data are sent and stored (3 MB of common data and two 1 MB chunks of delta data).

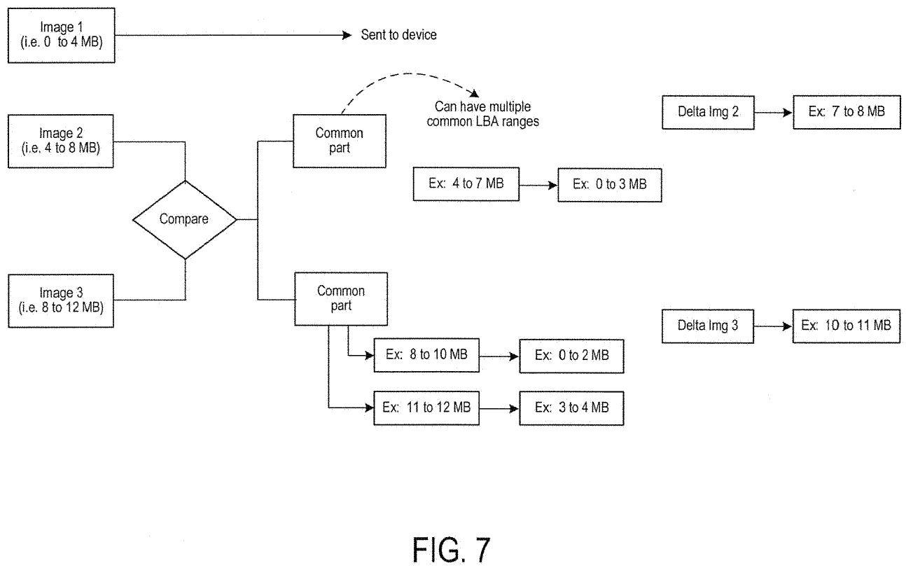

In the above example, the host 300 checked for delta data and then encoded and sent the images to the storage system 100. In another embodiment, the base data can be from an image previously sent to the storage system 100. For example, the host 300 can send a full image to the storage system 100, and delta data for subsequent images can be calculated by comparing with those images with a cached copy of the image previously sent to the storage system 100. This alternative is illustrated in FIG. 7. As shown in FIG. 7, the host 300 first sends Image 1 (LBA 0-4) to the storage system 100 for storage. The host 300 then analyzes subsequent images (here, Image 2 (LBA 4-8) and Image 3 (LBA 8-12)) to determine what parts of those images are common to Image 1. In this example, LBA 4-7 in Image 2 is common with LBA 0-3 in Image 1, and LBA 8-10 in Image 3 is common with LBA 0-2 in Image 1. Since the common data is already stored in the storage system 100, the host 300 just sends the delta data to the storage system 100 (in this example, LBA 7-8 for Image 2 and LBA 10-11 for Image 3). While these examples show the common data being at the beginning of the image, the common data can be elsewhere. For instance, FIG. 7 shows another example in which the common data is LBA 11-12 in Image 3 and LBA 3-4 in Image 1.

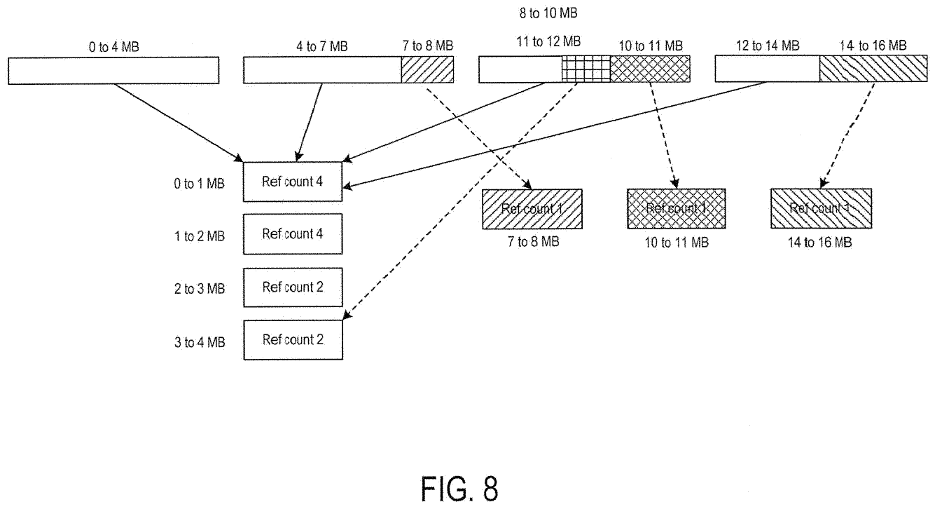

Turning now to the storage system 100, when the storage system 100 receives the common data and delta data for a plurality of images, the processor 102 (e.g., using the burst mode storage optimizer 111) stores the common data and delta data in the memory 104 of the storage system 100. The processor 102 also creates a map for the plurality of images, so the processor 102 can recreate any of the images from the common and delta parts. More specifically, each image of the plurality of images maps to a memory location of at least a part of the common image data and to a memory location of that image's delta image data. The controller 102 can also maintain a reference count for each memory location of each part of the common image data. That is, the storage system 100 can recognize the common and delta parts of an image and, for the common part, forego writing that data to memory and instead map it to existing data and increase a reference count (the delta part would be written to memory 104 though). This is illustrated in FIG. 8.

As shown in FIG. 8, a reference is increased for images pointing to the same common part and also for the delta parts. More particularly, in this example, LBA 0-4 are for a base image (Image 1) whose parts are shared by Images 2-4, although with different parts shared in different ones of those images. Here, LBA 4-7 in Image 2 shares LBA 0-3 in Image 1, LBA 8-10 in Image 3 shares LBA 0-2 in Image 1, and LBA 12-14 in Image 4 shares LBA 0-2 in Image 1. The LBAs of the shared parts are associated with a reference number that indicates how many times an LBA is shared. For example, because LBA 0-1 is shared among all the images, its reference count is four. On the other hand, because the delta data is only used with a single image, the reference count for the LBAs for the delta data is 1. The reference count for each LBA can be reduced in response to an erase operation to that memory location, and the data in that location can be erased when the reference count drops to zero.

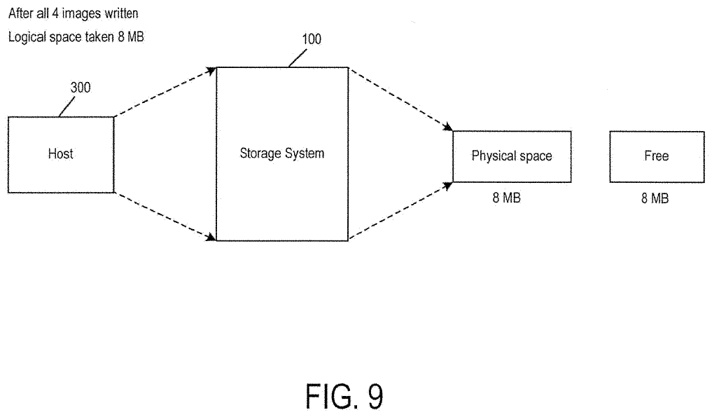

FIG. 9 is a diagram that illustrates the advantage of this embodiment as applied to the example in FIG. 8. Instead of receiving and storing 16 MB (4 MB for each of the four images), the storage system 100 only receives and stores 8 MB, effectively creating 8 MB of free space.

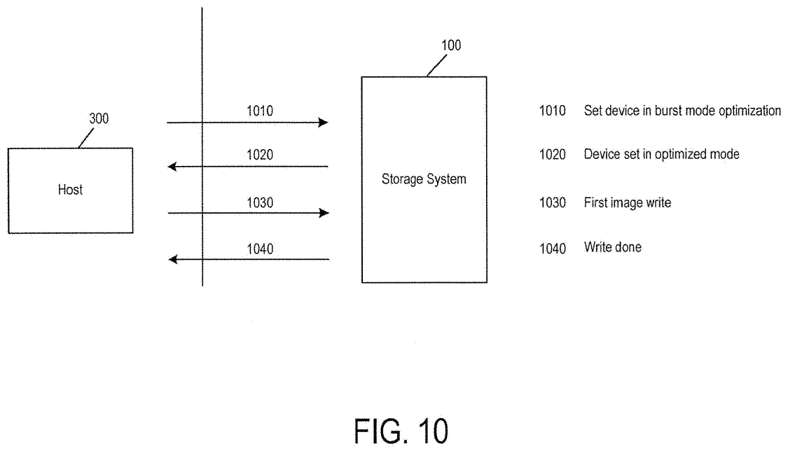

In another embodiment, the storage system 100, not the host 300, determines the common and delta parts of a plurality of images. This alternative shifts the handling from the host 300 to the storage system 100 and is illustrated in FIG. 10. As shown in FIG. 10, the host 300 sends an indication to the storage system 100 that the host 300 is operating in burst mode (act 1010). The host 300 can send this signal after recognizing that a plurality of images has been taken over a pre-defined, short time interval. In response to the signal, the storage system's processor 102 is configured to detect overlaps in images (act 1020). Next, the host 300 sends the first image to the storage system 100 (act 1030). After the processor 102 stores the first image in the memory 104, it sends an acknowledgement signal to the host (act 1040).

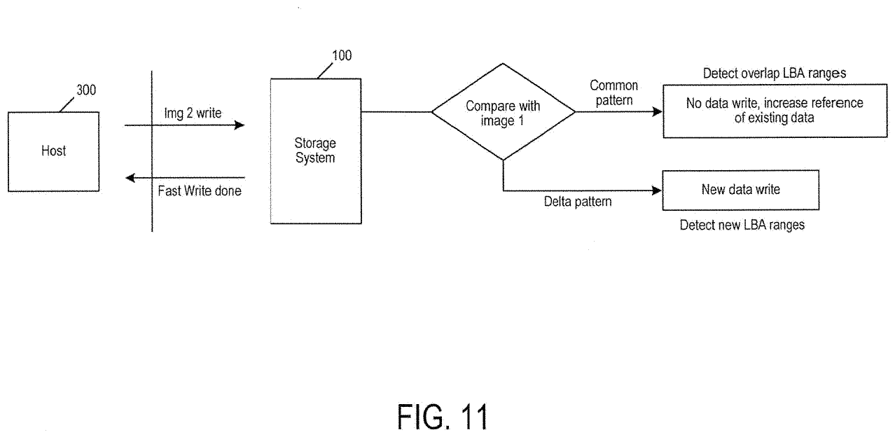

The processor 102 of the storage system 100 then scans subsequent new images to find the common and delta parts for those images. The common parts are mapped to earlier LBA range data, and the references for those LBAs are increased. That is, the processor 102 recognizes the common and delta parts and, for the common parts, it does not write any redundant data but instead maps to the existing data and increases the reference. For the delta part, the new data is written, and a reference is created. This is illustrated in FIG. 11.

As shown in FIG. 11, in this example, the processor 102 loads already-stored Image 1 and computes the difference between Image 2 and Image 1. Since image decoding does not require a lot of processing, the processor 102 can compute the difference at run time or by using a hardware module. The processor 102 can utilize the host buffers if required.

There are several advantages associated with these embodiments. As discussed above, by only storing the delta part, the memory's total space utilization remains low compared to stored full images. Since all the data is not written and only differential data is written, memory space is utilized better. Also, by writing less data to blocks in the memory 102, write amplification is decreased. Finally, as also noted above, since only differential data is transferred by the host 300, less bus bandwidth is consumed.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A storage system comprising:
a memory; and
a controller configured to:
receive, from a host, common image data that is shared by a plurality of images and delta image data that is different in each of the plurality of images;
store the common image data and the delta image data in the memory; and
create a map for the plurality of images, wherein each image of the plurality of images maps to a memory location of at least a part of the common image data and to a memory location of that image's delta image data.

2. The storage system of claim 1, wherein the memory locations are identified by logical block addresses.

3. The storage system of claim 1, wherein the controller is further configured to maintain a reference count for each memory location of each part of the common image data.

4. The storage system of claim 3, wherein the controller is further configured to reduce the reference count of a memory location in response to an erase operation to that memory location.

5. The storage system of claim 4, wherein the controller is further configured to erase data at a memory location in response to the reference count of that memory location being zero.

6. The storage system of claim 1, wherein the controller is configured to create the map in response to receiving an indication from the host that the host is operating in a burst mode.

7. The storage system of claim 1, wherein the memory comprises a three-dimensional memory.

8. The storage system of claim 1, wherein the storage system is configured to be removably connected to the host.

9. The storage system of claim 1, wherein the storage system is configured to be embedded in the host.

10. A method comprising:
performing the following in a host in communication with a storage system:
determining base data that is common to a plurality of images;
determining delta data that is different in each of the plurality of images; and
sending the base data and the delta data to the storage system, wherein a size of the base data and the delta data is less than a size of the plurality of images,

11. The method of claim 10, wherein the base data is from an image previously sent to the storage system.

12. The method of claim 10, wherein the host comprises an image capture device configured to capture the plurality of images.

13. The method of claim 10, wherein the plurality of images was taken while the host was in a burst mode, and wherein the method further comprises informing the storage system of the burst mode.

14. The method of claim 10, wherein the storage system is configured to be removably connected to the host.

15. The method of claim 10, wherein the storage system is configured to be embedded in the host.

16. A storage system comprising:
a memory; and
means for storing a first image received from a host in the memory; and
means for performing the following for a second image received from the host:
determining data that is common between the first image and the second image;
determining data that is different between the first image and the second image;
storing the data that is different, but not the data that is common, in the memory; and
storing a reference to a location in the memory storing the data that is common.

17. The storage system of claim 16, further comprising means for maintaining a count for a number of references to each memory location.

18. The storage system of claim 16, wherein the means for performing is activated in response to receiving an indication from the host that the host is operating in a burst mode.

19. The storage system of claim 16, wherein the storage system is configured to be removably connected to the host.

20. The storage system of claim 16, wherein the storage system is configured to be embedded in the host.
